(19) United States
(12) Patent Application Publication
(10) Pub. No.: US 2014/0310266 A1
(43) Pub. Date: Oct. 16, 2014

(54) Systems and Methods for Suggesting Places for Persons to Meet

(71) Applicant: GOOGLE Inc., (US)

(72) Inventor: Samuel Edward Greenfield, Brooklyn, NY (US)

(73) Assignee: GOOGLE Inc., Mountain View, CA (US)

(21) Appl. No.: 13/860,121

(22) Filed: Apr. 10, 2013

(51) Int. Cl. G06F 17/30

(52) U.S. Cl. CPC G06F 17/3053
USPC 707/723

(57) ABSTRACT

Embodiments include a computer-implemented method that includes receiving a first geographic location, a second geographic location, and a search topic, identifying an intermediate location between the first and second geographic locations, wherein at least one of the travel times or the travel distances from the intermediate location to each of the first and second locations are approximately equal, identifying a set of search results responsive to the search topic, wherein each search result is associated with a location that is within a predetermined distance of the intermediate location, ranking each of the search results based at least in part on the location associated with the search result, and providing the set of ranked search results for display.

### BACKGROUND OF THE INVENTION

1. Field of the Invention

Embodiments of this invention relate generally to search industries and, more particularly, to special purpose machines, systems, methods and computer instructions for suggesting places to meet.

2. Description of the Related Art

Persons often employ searches to locate nearby businesses or other locations of interest. For example a person may search for “restaurant” in hopes of finding a nearby restaurant. In some instances, a person may provide additional search information, such as a particular location, in an effort to narrow their search. For example, a person in New York City may search for “new york city restaurants” in hopes of finding restaurants that are located in New York City. Although this traditional searching technique may provide a suitable set of results relating to a location of interest, it may not provide a reliable option for users searching for a meeting place between multiple locations. For example, if two people located across town from one another want to meet for dinner, one of them may submit a search for “restaurant” using a traditional search environment, and then sift through the search results to find a location that seems to be a good meeting place. Although a meeting place can be located in this manner, it requires a substantial amount of effort and may not help the user to find a meeting place that is convenient to both persons. For example, where the person searching selects a location that appears to be at a mid-point between the two persons' locations, the travel times from each of the locations may be considerably different, requiring one of them to travel a great deal longer than the other.

### SUMMARY OF THE INVENTION

Various embodiments of methods and apparatus for suggesting a meeting place based on two or more locations. In some embodiments, provided is a computer-implemented method that includes receiving, via a user device, a first geographic location, a second geographic location, and a search topic, identifying, by one or more processors, an intermediary intermediate location having an approximately equal travel time from between the first and second geographic locations, wherein at least one of the travel times or the travel distances from the intermediate location to each of the first and second locations are approximately equal, identifying, by the one or more processors, a set of search results responsive to the search topic, wherein each search result is associated with a location that is within a predetermined distance of the intermediate location, ranking, by the one or more processors, each of the search results based at least in part on proximity of the locations associated with the search results to the intermediary location to generate a ranked set of search results, and providing the set of ranked search results for display via the user device.

In some embodiments, provided is a system including one or more memories storing instructions and one or more processors coupled to the one or more memories and configured to execute the instructions stored thereon to cause the following steps: receiving a first geographic location, a second geographic location, and a search topic, identifying an intermediate location between the first and second geographic locations, wherein at least one of the travel times or the travel distances from the intermediate location to each of the first and second locations are approximately equal, identifying a set of search results responsive to the search topic, wherein each search result is associated with a location that is within a predetermined distance of the intermediate location, ranking each of the search results based at least in part on the location associated with the search result, and providing the set of ranked search results for display.

In some embodiments, provided is a non-transitory computer readable medium having program instructions stored thereon that are executable by a processor to cause the following steps: receiving a first geographic location, a second geographic location, and a search topic, identifying an intermediate location between the first and second geographic locations, wherein at least one of the travel times or the travel distances from the intermediate location to each of the first and second locations are approximately equal, identifying a set of search results responsive to the search topic, wherein each search result is associated with a location that is within a predetermined distance of the intermediate location, ranking each of the search results based at least in part on the location associated with the search result, and providing the set of ranked search results for display.

### BRIEF DESCRIPTION OF THE DRAWINGS

FIG. 1 is a flowchart that illustrates a method of suggesting a meeting place in accordance with one or more embodiments of the present invention.

FIG. 2 illustrates a search results webpage that includes suggested meeting locations in accordance with one or more embodiments of the present invention.

FIG. 3 is a block diagram that illustrates a search query environment in accordance with one or more embodiments of the present invention.

FIG. 4 is a block diagram that illustrates an exemplary computer system in accordance with one or more embodiments of the present invention.

### DETAILED DESCRIPTION

As discussed in more detail below, provided are systems and methods for suggesting a meeting place based on two or more locations, referred to herein as a multi-location search. A multi-location search may enable a user to provide a first location, a second location and a search topic, and receive search results that are responsive to the search topic and that correspond to places located between the first and second locations, or at least approximately the same distance or travel time from each of these locations. Such a multi-location search may be useful for suggesting a place for people to meet. For example, if two people want to meet for dinner and they are located across town from one another, one of them could submit a multi-location search for “restaurant” along with each of their locations, and the multi-location search would return results for restaurants in locations having approximately the same travel times from each of their locations.

In some embodiments, the multi-location search includes (1) receiving a multi-location search query, including the following: (a) a first geographic location, (b) a second geographic location, and (c) a search topic; (2) identifying one or more intermediate locations having an approximately equal travel time from the first and second geographic locations; (3) identifying a set of search results responsive to the search topic, (4) ranking the search results based at least in part on proximity of the locations associated with the search results to the one or more intermediate locations to generate a ranked set of search results, and (5) providing the set of ranked search results (i.e., the suggested places to meet) for display to the user.

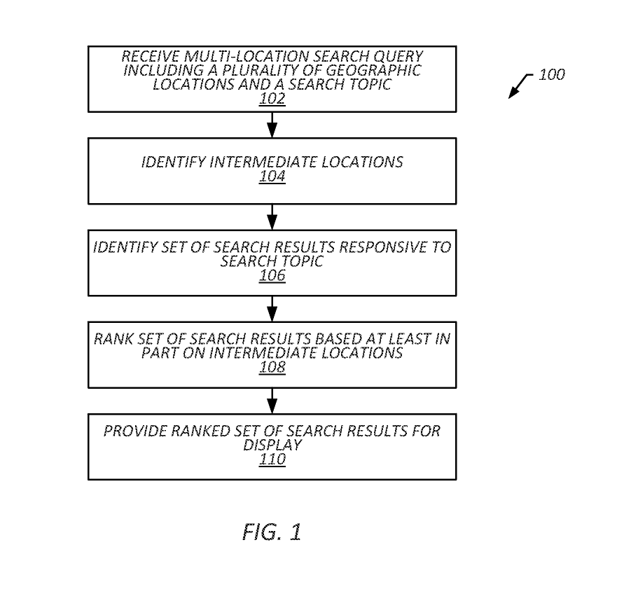

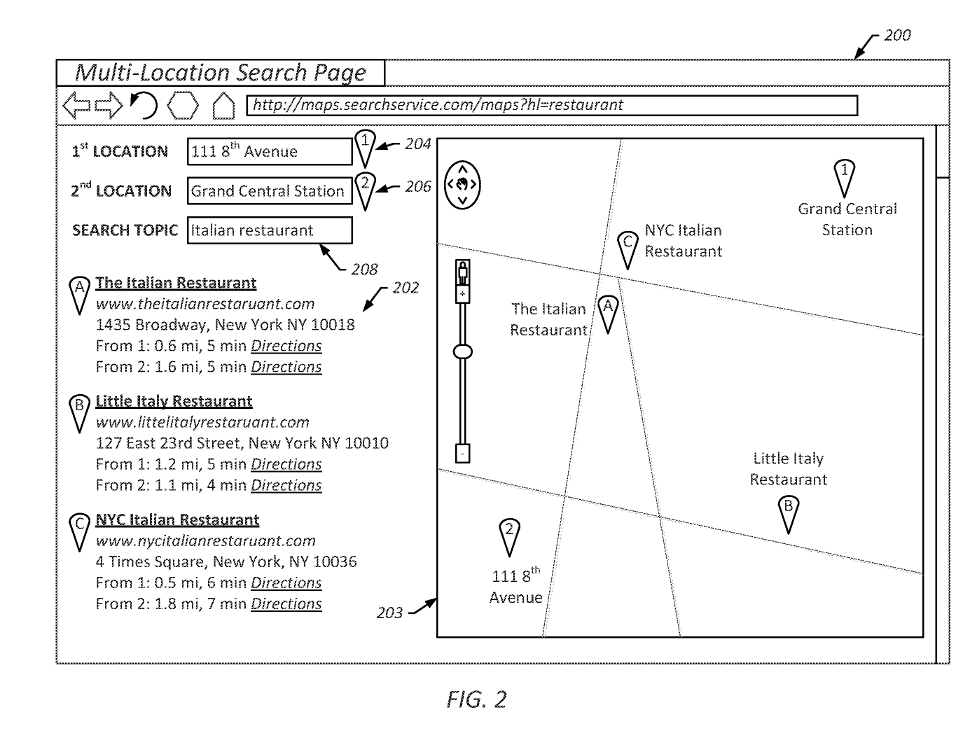

FIG. 1 is a flowchart that illustrates a method 100 of employing a multi-location search to suggest a meeting place in accordance with one or more embodiments of the present invention. Method 100 may include receiving a multi-location search query (block 102). In some embodiments, the multi-location search query includes multiple geographic locations and a search topic. For example, a user may visit a multi-location webpage (e.g., similar to multi-location search webpage 200 depicted in FIG. 2) and submit a multi-location search query that specifies a first location of “111 8^{th} Avenue” (e.g., a current location of the person submitting the search), a second location of “Grand Central Station” (e.g., a current location of the person they are meeting), and a search topic of “Italian restaurant” (e.g., based on the two wanting to meet at an Italian restaurant).

Method 100 may include identifying intermediate locations (block 104). In some embodiments, identifying intermediate locations includes identifying one or more locations that are located approximately the same travel time and/or distance from the two locations. Travel times may be estimated based on various travel conditions, such as distance, speed limits, traffic, available modes of transportation, and so forth. In some embodiments, identifying intermediate locations includes identifying a set of geographic points (e.g., latitude and longitude coordinates) that are approximately the same travel time and/or distance from the two locations. In some embodiments, the points may be identified with a given level of granularity, e.g., in 0.25 km increments. In some embodiments, identifying intermediate locations includes identifying geographic cells (or tiles) that bound regions that are approximately the same travel time and/or distance from the two locations. In accordance with the example provided above, the intermediate locations may include, for example, a cell that includes Times Square in New York City, a cell that includes the Garment District in New York City, the Flatiron District in New York City, and so forth—each having an approximate travel time of about five min from both “111 8^{th} Avenue” and “Grand Central Station.” In some instances, the travel time and/or distance from the first or second locations to a cell may be determined based on travel to a centroid of the cell. For example, where a centroid of the cell including Times Square is located at Broadway and West 42^{nd} Street, the travel time and/or distance from “111 8^{th} Avenue” and “Grand Central Station”, may be calculated from Broadway and West 42^{nd} Street to the respective locations.

Method 100 may include identifying a set of search results responsive to the search topic (block 106). In accordance with the example provided above, identifying a set of search results responsive to the search topic may include identifying a set of search results responsive to the search topic “Italian restaurant”. In some embodiments, the set of search results is identified by querying a search index for places that are categorized as an Italian restaurant. The set of results may include, for example, Italian restaurants located in New York (e.g., “NYC Italian Restaurant”, “Little Italy Restaurant”, “The Italian Restaurant”, “Times Square Pizza”, and so forth) as well as other locations (e.g., Italian restaurants in New Jersey, Brooklyn, and so forth). At this point, the set of search results may include a raw-unranked list of search results. In some embodiments, identifying a set of search results may include identifying search results that are responsive to the search topic and to at least one of the identified intermediate locations (e.g., that are less than a predetermined distance from the intermediate location).

Method 100 may include ranking the set of search results based at least in part on the intermediate locations (block 108). In some embodiments, ranking the set of search results based at least in part on the intermediate locations includes scoring/ranking the search results based on proximity to the intermediate locations. For example, a search result for a place located in the same cell as an intermediate location (or within a short distance of the centroid of that cell) may receive a boost in score/rank (based on proximity to an intermediate location) than a search result for a place located outside of the identified cell or a greater distance away from a centroid of the identified cell.

In some embodiments, ranking the set of search results includes ranking the search results based on proximity of a place/location associated with the search result to the two locations. Proximity can be measured by net distance to the locations identified in the multi-location search, or net travel time to the locations identified in the multi-location search. For example, a search result for a place having a total travel time of nine minutes (e.g., a five minute travel time from the first location and a four minute travel time from the second location) may receive a greater boost in score/rank (based on net travel time proximity) than a search result for a place having total travel time of fifteen minutes. As a further example, a search result for a place having a total travel distance of five miles (e.g., a two mile travel distance from the first location and a three mile travel distance from the second location) may receive a greater boost in score/rank (based on net travel distance proximity) than a search result for a place having total travel time of ten miles.

In some embodiments, ranking the set of search results includes ranking the search results based on a travel imbalance, where a travel imbalance represents a difference in travel times or distances between the search result location and each of the locations identified in the multi-location search. For example, a search result for a place having a travel imbalance of one minute (e.g., a five minute travel time from the first location and a four minute travel time from the second location) may receive a greater boost in score/rank (based on travel time imbalance) than a search result for a place having a travel imbalance of five minutes. As a further example, a search result for a place having a total travel distance imbalance of one mile (e.g., a two mile travel distance from the first location and a three mile travel distance from the second location) may receive a greater boost in score/rank (based on travel distance imbalance) than a search result for a place having a travel distance imbalance of five miles.

In some embodiments, ranking the set of search results includes ranking the search results based on relevancy. For example, a search result for a place that is an Italian restaurant may receive a greater boost in score/rank than a place that is a pizza parlor. As a further example, a search result for a place that has favorable user reviews may receive a greater boost in score/rank than a place that has unfavorable user reviews.

In some embodiments, ranking the set of search results based at least in part on the intermediate locations includes generating a composite score for the search results and ranking the results relative to one another based on their composite scores. For example, a composite score for each of “NYC Italian Restaurant”, “Little Italy Restaurant”, “The Italian Restaurant”, “Times Square Pizza”, and so forth may be generated by determining and adding scores in one or more of the applicable scoring categories (e.g., categories of proximity to an intermediate location, net travel time/net travel distance proximity, travel time/travel distance imbalance, and relevance) and/or applying corresponding scoring multipliers for one or more of the applicable scoring categories to a baseline score for the search results. For example, a composite score for a search result can be computed by multiplying a relevance score by a distance imbalance score, or by dividing the relevance score by the net travel time score, or by multiplying the relevance score by the distance imbalance score and dividing by the net travel time score. Other combinations are of course possible, and within the scope of the invention. Once composite scores are determined for each of the search results, they can be ranked. For example, the search results may be ranked in the order of “The Italian Restaurant”, “Little Italy Restaurant”, “NYC Italian Restaurant”, and “Times Square Pizza” based on respective composite scores of eight, six, five, and two.

Method 100 may include providing the ranked set of search results for display (block 110). The ranked set of search results may be referred to as “suggested meeting locations” based on the first and second location and the search topic. FIG. 2 illustrates a search results webpage 200 that includes suggested meeting locations 202. The suggested meeting locations 202 correspond to the three highest ranked search results of the exemplary set of ranked search results discussed with regard to block 108. Webpage 200 also includes a map 203 having markers corresponding to the first and second locations (e.g., markers “1” and “2”), as well as markers corresponding to the suggested meeting locations (e.g., markers “A”, “B” and “C”). The meeting locations 202 may be identified and displayed in response to the user providing the first location in field 204, the second location in field 206 and the query topic in field 208, and selecting the search button. Thus, method 100 may provide a set of suggested meeting locations (e.g., “The Italian Restaurant”, “Little Italy Restaurant”, “NYC Italian Restaurant”) based at least in part on multiple locations and a search topic provided by a user.

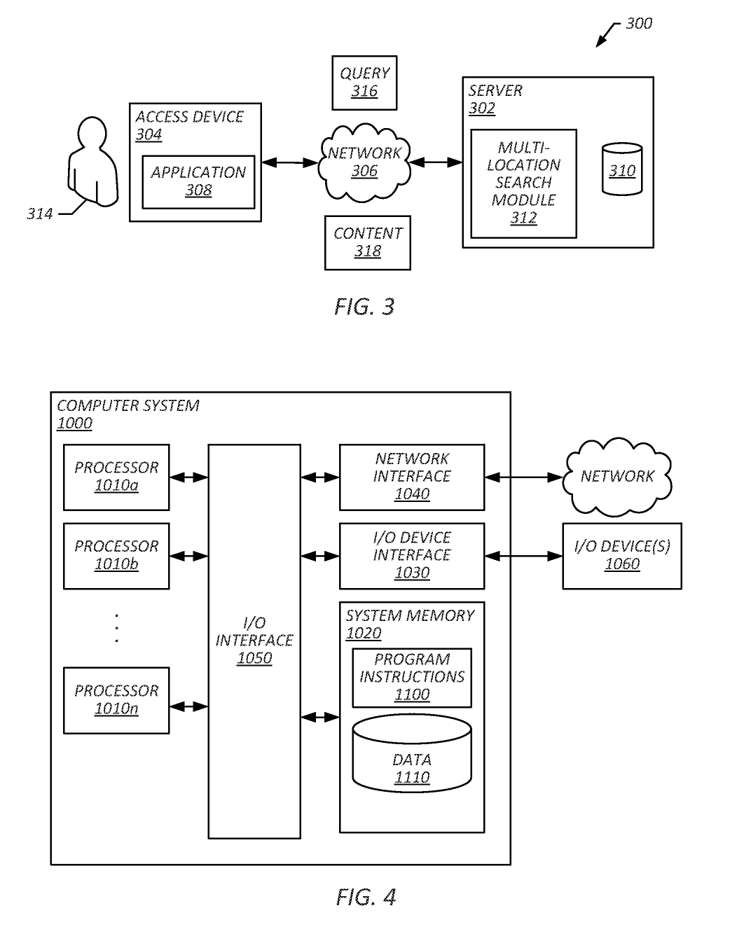

Methods 100 is an exemplary embodiment of a method that may be employed in accordance with the techniques described herein. Method 100 may be modified to facilitate variations of its implementations and uses. Method 100 may be implemented in software, hardware, or a combination thereof. Some or all of method 100 may be implemented by one or more of the modules/applications described herein, such as multi-location search module 312 and/or application 308 depicted and described in more detail below with regard to FIG. 3. The order of the steps of method 100 may be changed, and various elements may be added, reordered, combined, omitted, modified, etc.

FIG. 3 is a block diagram that illustrates an exemplary query environment 300. Environment 300 includes a server 302 and access device 304 communicatively coupled via a network 306.

Network 306 may include an electronic communications network, such as the Internet, a local area network (LAN), a wide area (WAN), a cellular communications network or the like. Network 306 may include a single network or combination of networks.

Access device 304 may include any variety of electronic devices. For example, access device 304 may include a personal computer (e.g., a desktop computer), a mobile computing device (e.g., a laptop, tablet computer, a cellular phone, a personal digital assistant (PDA), etc.), or the like. In some embodiments, access device 304 is a client of server 302. In some embodiments, access device 304 includes various input/output (I/O) interfaces, such as a graphical user interface (e.g., display screen), an audible output user interface (e.g., speaker), an audible input user interface (e.g., microphone), a keyboard, a pointer/selection device (e.g., mouse, trackball, touchpad, touchscreen, stylus, etc.), a printer, or the like. In some embodiments, access device 304 includes general computing components and/or embedded systems optimized with specific components for performing specific tasks. In some embodiments, access device 304 includes application 308. Application 308 may include one or more modules having program instructions that are executable by a computer system to perform some or all of the functionality described herein with regard to access device 304. An application may include, for example, an Internet browser, a search application (e.g., a multi-location search application for identifying meeting locations) or similar application that facilitates communication with server 302 and/or other entities of environment 300. In some embodiments, access device 304 includes a computer system similar to that of computer system 1000 described below with regard to at least FIG. 4.

Server 302 may include a network entity that serves requests by client entities. For example, server 302 may serve requests generated by access device 304. In some embodiments, server 302 hosts a content site, such as a website, a file transfer protocol (FTP) site, an Internet search website or other source of network content. In some embodiments, server 302 includes a search and/or mapping server. In some instances, server 302 may serve webpages or the like in response to requests generated by access device 304. In some embodiments, server 302 includes or otherwise has access to data store 310. Data store 310 may include a database or similar data repository. For example, data store 310 may include a search index used for servicing search request.

In some embodiments, server 302 includes a multi-location search module 312. Module 312 may include program instructions that are executable by a computer system to perform some or all of the functionality described herein. For example, module 312 may include program instructions that are executable by a computer system to perform some or all of the steps of method 100. In some embodiments, server 302 includes a computer system similar to that of computer system 1000 described below with regard to at least FIG. 4. Although server 302 is represented by a single box in FIG. 3, server 302 may include a single server (or similar system), or a plurality of servers (and/or similar systems). For example, server 302 may include a plurality of different servers (and/or similar systems) that are employed individually or in combination to perform some or all of the functionality described herein with regard to server 302.

In some embodiments environment 300 is used to employ techniques described herein. For example, a user 314 may submit a multi-location search query 316 to server 302 using application 308 of access device 304. Module 312 may process the multi-location search query (e.g., as described with regard to at least method 100) to identify a set of ranked search results (e.g., including suggested places to meet). Content 318 including the set of ranked search results (e.g., webpage 200) may be served to access device 304, and application 308 may render content 318 for display to user 314. Thus, user 314 may be presented with a list of suggested meeting locations (e.g., “The Italian Restaurant”, “Little Italy Restaurant”, “NYC Italian Restaurant”) based at least in part on multiple locations and a search topic.

Exemplary Computer System

FIG. 4 is a block diagram that illustrates an exemplary computer system 1000. Various portions of systems and methods described herein, may include or be executed on one or more computer systems similar to system1. For example, server 302 and/or access device 304 may include a configuration similar to at least a portion of computer system 1000. Further, methods/processes/modules described herein (e.g., module 312 and/or application 308) may be executed by one or more processing systems similar to that of computer system 1000.

Computer system 1000 may include one or more processors (e.g., processors 1010a-1010n) coupled to system memory 1020, an input/output I/O device interface 1030 and a network interface 1040 via an input/output (I/O) interface 1050. A processor may include a single processor device and/or a plurality of processor devices (e.g., distributed processors). A processor may be any suitable processor capable of executing/performing instructions. A processor may include a central processing unit (CPU) that carries out program instructions to perform the basic arithmetical, logical, and input/output operations of computer system 1000. A processor may include code (e.g., processor firmware, a protocol stack, a database management system, an operating system, or a combination thereof) that creates an execution environment for program instructions. A processor may include a programmable processor. A processor may include general and/or special purpose microprocessors. A processor may receive instructions and data from a memory (e.g., system memory 1020). Computer system 1000 may be a uni-processor system including one processor (e.g., processor 1010a), or a multi-processor system including any number of suitable processors (e.g., 1010a-1010n). Multiple processors may be employed to provide for parallel and/or sequential execution of one or more portions of the techniques described herein. Processes and logic flows described herein may be performed by one or more programmable processors executing one or more computer programs to perform functions by operating on input data and generating corresponding output. Processes and logic flows described herein may be performed by, and apparatus can also be implemented as, special purpose logic circuitry, e.g., an FPGA (field programmable gate array) or an ASIC (application specific integrated circuit). Computer system 1000 may include a computer system employing a plurality of computer systems (e.g., distributed computer systems) to implement various processing functions.

I/O device interface 1030 may provide an interface for connection of one or more I/O devices 1060 to computer system 1000. I/O devices may include any device that provides for receiving input (e.g., from a user) and/or providing output (e.g., to a user). I/O devices 1060 may include, for example, graphical user interface displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface may 1040 may facilitate data exchange between computer system 1000 and other devices connected to the network. Network interface 1040 may support wired or wireless communication. The network may include an electronic communication network, such as the Internet, a local area network (LAN), a wide area (WAN), a cellular communications network or the like.

System memory 1020 may be configured to store program instructions 1100 and/or data 1110. Program instructions 1100 may be executable by a processor (e.g., one or more of processors 1010a-1010n) to implement one or more embodiments of the present technique. Instructions 1100 may include modules of computer program instructions for implementing one or more techniques described herein with regard to various processing modules. Program instructions may include a computer program (also known as a program, software, software application, script, or code). A computer program may be written in any form of programming language, including compiled or interpreted languages, or declarative/procedural languages. A computer program may include a unit suitable for use in a computing environment, including as a stand-alone program, a module, a component, a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a non-transitory computer readable storage medium, such as a machine readable storage device, a machine readable storage substrate, a memory device, or any combination thereof, or the like. Non-transitory computer readable storage medium may include, non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium having program instructions stored thereon that are executable by a computer processor (e.g., one or more of processors 1010a-1010n) to cause some or all of the subject matter and the functional operations described herein. A memory (e.g., system memory 1020) may include a single memory device and/or a plurality of memory devices (e.g., distributed memory devices).

I/O interface 1050 may be configured to coordinate I/O traffic between processors 1010a-1010n, system memory 1020, network interface 1040, I/O devices 1060 and/or other peripheral devices. I/O interface 1050 may perform protocol, timing or other data transformations to convert data signals from one component (e.g., system memory 3020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000, or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices and/or software that may perform or otherwise provide for the performance of the techniques described herein. For example, computer system 1000 may include a desktop computer, a laptop computer, a tablet computer, a server device, a client device, a mobile telephone, a personal digital assistant (PDA), a mobile audio or video player, a game console, a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations.

It should be understood that the description and the drawings are not intended to limit the invention to the particular form disclosed, but to the contrary, the intention is to cover all modifications, equivalents, and alternatives falling within the spirit and scope of the present invention as defined by the appended claims. Further modifications and alternative embodiments of various aspects of the invention will be apparent to those skilled in the art in view of this description. Accordingly, this description and the drawings are to be construed as illustrative only and are for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” mean including, but not limited to. As used throughout this application, the singular forms “a”, “an” and “the” include plural referents unless the content clearly indicates otherwise. Thus, for example, reference to “an element” may include a combination of two or more elements. Unless specifically stated otherwise, as apparent from the discussion, it is appreciated that throughout this specification discussions utilizing terms such as “processing”, “computing”, “calculating”, “determining” or the like refer to actions or processes of a specific apparatus, such as a special purpose computer or a similar special purpose electronic processing/computing device. In the context of this specification, a special purpose computer or a similar special purpose electronic processing/computing device is capable of manipulating or transforming signals, typically represented as physical electronic or magnetic quantities within memories, registers, or other information storage devices, transmission devices, or display devices of the special purpose computer or similar special purpose electronic processing/computing device.

What is claimed is:

1. A computer-implemented method comprising:
receiving, via a user device, a first geographic location, a second geographic location, and a search topic;
identifying, by one or more processors, an intermediate location between the first and second geographic locations, wherein at least one of the travel times or the travel distances from the intermediate location to each of the first and second locations are approximately equal;
identifying, by the one or more processors, a set of search results responsive to the search topic, wherein each search result is associated with a location that is within a predetermined distance of the intermediate location;
ranking, by the one or more processors, each of the search results based at least in part on the location associated with the search result; and
providing the set of ranked search results for display via the user device.

2. The method of claim 1, wherein ranking each of the search results further comprises ranking each search result based on a proximity between the location of the search result and the intermediate location.

3. The method of claim 2, wherein the intermediate location comprises a map cell, and wherein the travel times or the travel distances from the intermediate location to each of the first and second geographic locations are measured from the centroid of the map cell.

4. The method of claim 1, wherein ranking each of the search results further comprises ranking each search result based at least in part on a net travel distance proximity, wherein the net travel distance proximity is measured with respect to the location of the search result and the first and second geographic locations.

5. The method of claim 1, wherein ranking each of the search results further comprises ranking each search result based at least in part on a net travel time proximity, wherein the net travel time proximity is measured with respect to the location of the search result and the first and second geographic locations.

6. The method of claim 1, wherein ranking each of the search results further comprises ranking each search result based at least in part on a travel time imbalance, wherein the travel time imbalance is measured with respect to the location of the search result and the first and second geographic locations.

7. The method of claim 1, wherein ranking each of the search results further comprises ranking each search result based at least in part on a travel distance imbalance, wherein the travel distance imbalance is measured with respect to the location of the search result and the first and second geographic locations.

8. A system comprising:
one or more memories storing instructions; and
one or more processors coupled to the one or more memories and configured to execute the instructions stored thereon to perform the following steps:
receiving a first geographic location, a second geographic location, and a search topic;
identifying an intermediate location between the first and second geographic locations, wherein at least one of the travel times or the travel distances from the intermediate location to each of the first and second locations are approximately equal;
identifying a set of search results responsive to the search topic, wherein each search result is associated with a location that is within a predetermined distance of the intermediate location;
ranking each of the search results based at least in part on the location associated with the search result; and
providing the set of ranked search results for display.

9. The system of claim 8, wherein ranking each of the search results further comprises ranking each search result based on a proximity between the location of the search result and the intermediate location.

10. The system of claim 9, wherein the intermediate location comprises a map cell, and wherein the travel times or the travel distances from the intermediate location to each of the first and second geographic locations are measured from the centroid of the map cell.

11. The system of claim 8, wherein ranking each of the search results further comprises ranking each search result based at least in part on a net travel distance proximity, wherein the net travel distance proximity is measured with respect to the location of the search result and the first and second geographic locations.

12. The system of claim 8, wherein ranking each of the search results further comprises ranking each search result based at least in part on a net travel time proximity, wherein the net travel time proximity is measured with respect to the location of the search result and the first and second geographic locations.

13. The system of claim 8, wherein ranking each of the search results further comprises ranking each search result based at least in part on a travel time imbalance, wherein the travel time imbalance is measured with respect to the location of the search result and the first and second geographic locations.

14. The system of claim 8, wherein ranking each of the search results further comprises ranking each search result based at least in part on a travel distance imbalance, wherein the travel distance imbalance is measured with respect to the location of the search result and the first and second geographic locations.

15. A non-transitory computer readable medium comprising program instructions stored thereon that are executable by a processor to cause the following steps:
receiving a first geographic location, a second geographic location, and a search topic;
identifying an intermediate location between the first and second geographic locations, wherein at least one of the travel times or the travel distances from the intermediate location to each of the first and second locations are approximately equal;
identifying a set of search results responsive to the search topic, wherein each search result is associated with a location that is within a predetermined distance of the intermediate location;
ranking each of the search results based at least in part on the location associated with the search result; and
providing the set of ranked search results for display.

16. The medium of claim 15, wherein ranking each of the search results further comprises ranking each search result based on a proximity between the location of the search result and the intermediate location.

17. The medium of claim 16, wherein the intermediate location comprises a map cell, and wherein the travel times or the travel distances from the intermediate location to each of the first and second geographic locations are measured from the centroid of the map cell.

18. The medium of claim 15, wherein ranking each of the search results further comprises ranking each search result based at least in part on a net travel distance proximity, wherein the net travel distance proximity is measured with respect to the location of the search result and the first and second geographic locations.

19. The medium of claim 15, wherein ranking each of the search results further comprises ranking each search result based at least in part on a net travel time proximity, wherein the net travel time proximity is measured with respect to the location of the search result and the first and second geographic locations.

20. The medium of claim 15, wherein ranking each of the search results further comprises ranking each search result based at least in part on a travel time imbalance, wherein the travel time imbalance is measured with respect to the location of the search result and the first and second geographic locations.

21. The medium of claim 15, wherein ranking each of the search results further comprises ranking each search result based at least in part on a travel distance imbalance, wherein the travel distance imbalance is measured with respect to the location of the search result and the first and second geographic locations.
